(19) United States
(12) Patent Application Publication
(10) Pub. No.: US 2016/0224111 A1
(43) Pub. Date: Aug. 4, 2016

(54) METHOD FOR CONTROLLING TOUCH SCREEN BY DETECTING POSITION OF LINE OF SIGHT OF USER

(71) Applicant: ESTSOFT CORP., Seocho-gu, Seoul (KR)

(72) Inventor: Jangjoong KIM, Seoul (KR)

(73) Assignee: ESTSOFT CORP., Seoul (KR)

(21) Appl. No.: 15/029,351

(22) PCT Filed: Sep. 15, 2014
(86) PCT No.: PCT/KR2014/008561

§ 371 Date: Apr. 14, 2016

(30) Foreign Application Priority Data
Oct. 15, 2013 (KR) 10-2013-0122551

(51) Int. Cl. G06F 3/01; G06F 3/041; G06F 3/0488; G06F 3/03; G06F 3/0484

(52) U.S. Cl. CPC G06F 3/013; G06F 3/0304; G06F 3/04845; G06F 3/04883; G06F 3/0416

(57) ABSTRACT

The present invention relates to a method for controlling a touch screen by detecting the position of the line of sight of a user and, more particularly, to a method for controlling a touch screen by detecting the position of the line of sight of a user, whereby a camera detects the position of the line of sight of the user in a touch screen terminal having the camera attached thereto, and the screen is changed in accordance with the operation of an input means that touches the periphery of the position of the line of sight. In accordance with the present invention, there is an effect that the user can enlarge or reduce the screen even with only one input means and rotate the screen after touching the screen for a certain period of time.

### TECHNICAL FIELD

The present invention relates to a method of controlling a touch screen by sensing a position of a line of sight, and more specifically, to a method of controlling a touch screen by sensing a position of a line of sight, in which a camera senses a position of the line of sight of a user in a touch screen terminal having the camera attached thereto, and the screen is changed in accordance with the operation of an input means touching the periphery of the position of the line of sight.

### BACKGROUND ART

A keypad button or a touch screen should be pressed to perform a function in a mobile communication terminal released recently. In such an operation method, a user handles the terminal by pressing a numeral corresponding to a desired menu using an input means (a finger, a stylus pen or the like) after visually receiving information (menu information) and determining an operation to be performed.

However, such a menu handling method has a problem of frequently inducing an error from a user having impairment in fingers and inducing an operation error of a user due to the difference between an input method (inputting menu information using the vision of the user) and an output method (pressing a numeral of a menu item to be selected).

In order to relieve such inconveniences, a technique of controlling a screen by grasping a position of the line of sight of a user and performing a specific operation based on the position of the line of sight is disclosed. Since a camera is installed on the front side in most of mobile communication terminals, tablet PCs or the like, control of screen using the line of sight can be easily performed if the camera is utilized.

FIG. 1 is a view showing a principle of a control method using the sense of vision according to a conventional technique, and FIG. 2 is a view showing a principle of a character input method according to a conventional technique.

Referring to the figures, a character input device using a line of sight according to a conventional technique recognizes a pupil of a user looking at a reference point through a camera. A distance of moving the pupil from the reference point to the position of the pupil of the user can be measured by confirming whether or not the user looks at a specific portion of a handling unit. In addition, the character input device using a line of sight calculates a change of angle corresponding to the measured distance of moving the pupil and processes to input a character corresponding to the calculated change of angle with reference to a previously prepared character table.

Referring to the figures, the character input device using a line of sight first confirms a position of a pupil through a camera. Then, if the pupil moves, the character input device measures a distance of moving the pupil from the initial position of the pupil and confirms a change of angle corresponding to the distance. Then, a character of a keypad positioned on a line extended from the pupil at a corresponding angle is input.

For example, when a word “Apple” is input, a user may perform the input through a process of looking at “A”, looking at “p” and the like after a pupil is recognized through a camera as shown in FIG. 1b.

In addition, even when characters are transmitted after all the characters are input, the user may transmit the characters by looking at a transmission button for a predetermined time.

However, although such a control method can be used to input the characters appearing on the touch screen, it is difficult to be applied to an operation of enlarging or reducing the screen or moving the screen by scrolling. In addition, the method of sensing a line of sight of a user and selecting a button placed at the position is difficult to be applied to a control method of handling a screen by touching two positions.

### DISCLOSURE OF INVENTION

### Technical Problem

Therefore, the present invention has been made in view of the above problems, and it is an object of the present invention to provide a method of controlling a touch screen by sensing a position of a light of sight, in which the screen is enlarged or reduced by calculating coordinates of a point where the line of sight of a user is positioned and sensing whether a position touched by an input means of the user is getting away from or getting close to the position of the line of sight.

Another object of the present invention is to provide a method of controlling a touch screen by sensing a position of a line of sight, in which when the input means of the user moves along an arc around the position of the line of sight of the user, the screen is rotated in a direction the same as the direction of moving the input means.

### Technical Solution

To accomplish the above objects, according to one aspect of the present invention, there is provided a method of controlling a touch screen by sensing a position of a line of sight, as a method of sensing a position of a line of sight 30 of a user in a touch screen type user terminal 100 attached with a camera 108 and controlling the screen to be changed in accordance with an operation of an input means 20, the method including: a first step of recognizing a pupil 10 of the user from an image photographed through the camera 108, by a control unit; a second step of grasping a position of the line of sight 30 that the pupil 10 of the user is looking at on a display 104 of the user terminal 100, by the control unit; a third step of grasping a position of a handling point 40 contacting with the input means if the user contacts with the display 104 using the input means 20; a fourth step of sensing a change in the position of the handling point 40 by the control unit if the user moves the input means 20 while contacting with the display 104; and a fifth step of controlling the screen to reduce an image displayed on the display 104 if the handling point 40 is getting close to the line of sight 30 and enlarge the image displayed on the display 104 if the handling point 40 is getting away from the line of sight 30, by the control unit.

According to another aspect of the present invention, there is provided a method of controlling a touch screen by sensing a position of a line of sight, as a method of sensing a position of a line of sight 30 of a user in a touch screen type user terminal 100 attached with a camera 108 and controlling the screen to be changed in accordance with an operation of an input means 20, the method including: a first step of recognizing a pupil 10 of the user from an image photographed through the camera 108, by a control unit; a second step of grasping a position of the line of sight 30 that the pupil 10 of the user is looking at on a display 104 of the user terminal 100, by the control unit; a third step of grasping a position of a handling point 40 contacting with the input means 20 if the user contacts with the display 104 using the input means 20; a fourth step of switching the user terminal 100 to a screen rotation mode by the control unit if the user touches the input means 20 to the handling point 40 for a predetermined time or more; and a fifth step of rotating an image displayed on the display 104 in a direction the same as a direction of moving the input means 20 if the user moves the input means 20 around the line of sight 30.

The fifth step includes the steps of: forming an imaginary circle around the position of the line of sight 30; and rotating the image clockwise or counterclockwise as much as a rotation angle of a radius connecting the line of sight 30 and the handling point 40, if the user moves the handling point 40 positioned on a circumference of the imaginary circle.

### Advantegeous Effects

According to the present invention, a user can enlarge or reduce a screen with only one input means and rotate the screen after touching the screen for a predetermined time.

### BRIEF DESCRIPTION OF THE DRAWINGS

FIG. 1 is a view showing a principle of a control method using the sense of vision according to a conventional technique.

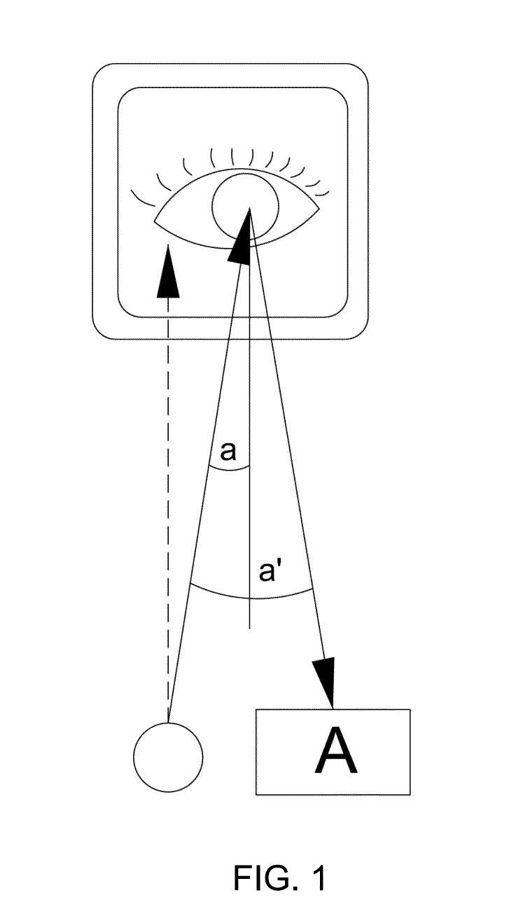

FIG. 2 is a view showing a principle of a character input method according to a conventional technique.

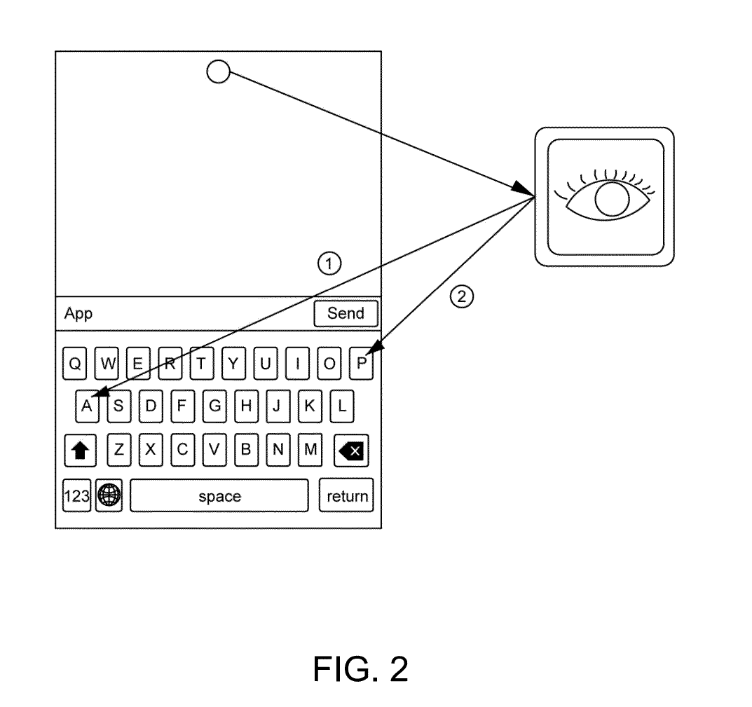

FIG. 3 is a conceptual view showing a method of grasping a position of a line of sight according to the present invention.

FIG. 4 is a conceptual view showing a method of enlarging or reducing a screen using an input means.

FIG. 5 is a flowchart illustrating a process of enlarging or reducing a screen.

FIG. 6 is a conceptual view showing a method of rotating a screen using an input means.

FIG. 7 is a flowchart illustrating a process of rotating a screen.

### BEST MODE FOR CARRYING OUT THE INVENTION

Hereinafter, a “method of controlling a touch screen by sensing a position of a line of sight” according to an embodiment of the present invention will be described with reference to the accompanying drawings.

Enlarging and Reducing Screen

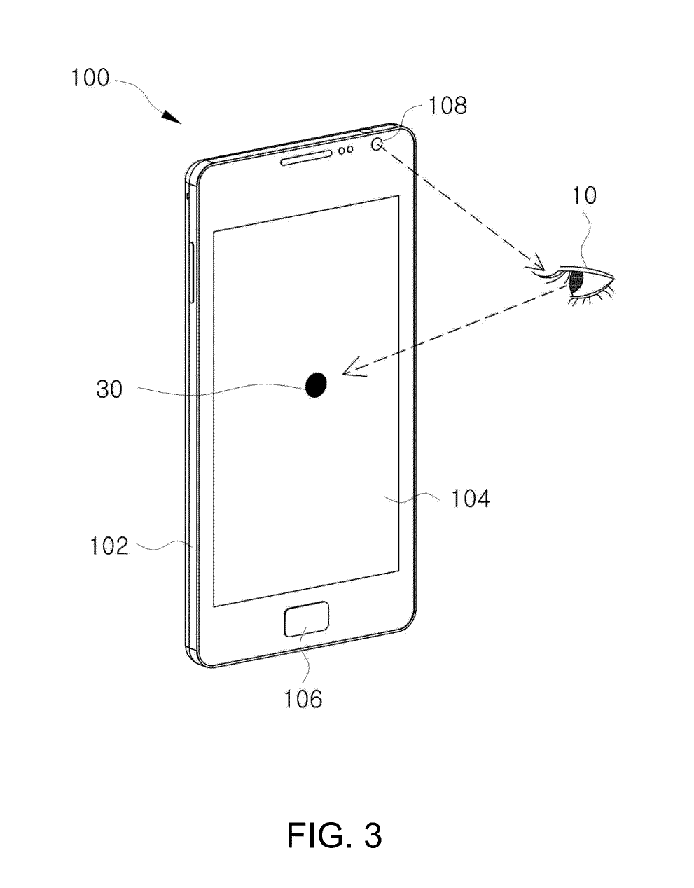

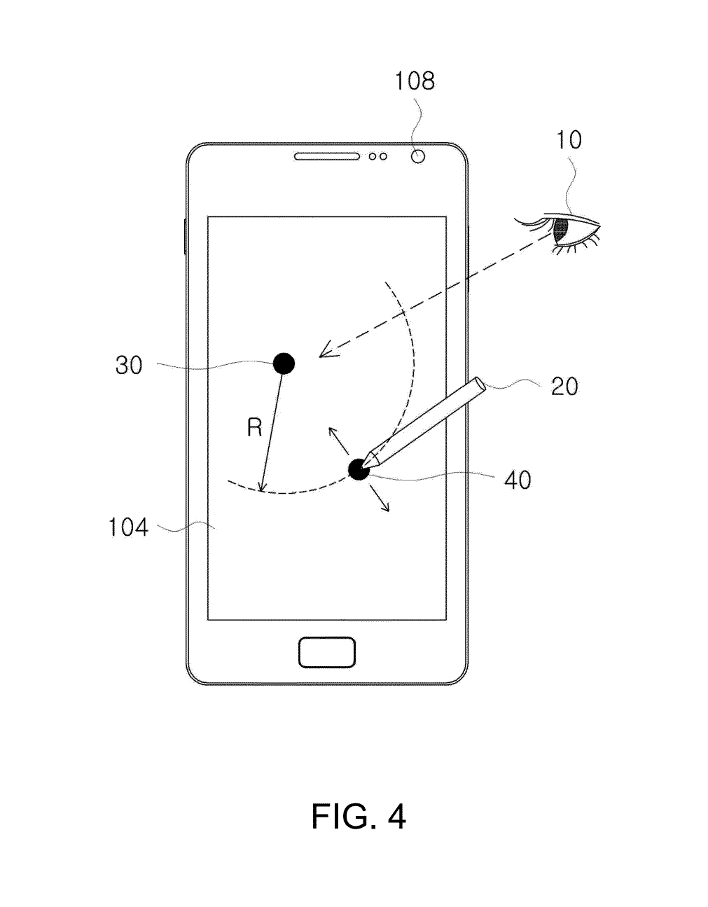

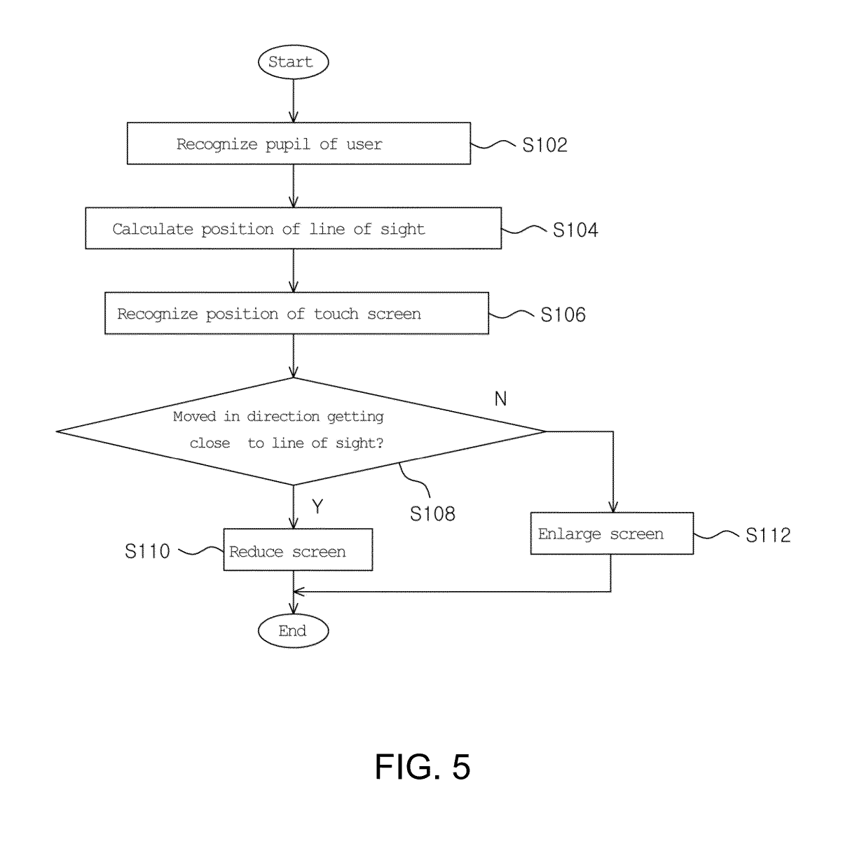

FIG. 3 is a conceptual view showing a method of grasping a position of a line of sight according to the present invention, FIG. 4 is a conceptual view showing a method of enlarging or reducing a screen using an input means, and FIG. 5 is a flowchart illustrating a process of enlarging or reducing a screen.

In order to execute the control method of the present invention, a user terminal 100 having a camera 108 installed therein should grasp a position of the line of sight 30 that the pupil 10 of the user is looking at. The user terminal 100 of the present invention includes all of a tablet PC, an MP3 player, a notebook computer and the like, as well as a mobile communication terminal such a cellular phone or a smart phone. However, a display 104 inside a case 102 should be controlled in a touch screen method. A control unit (not shown) of the user terminal 100 senses the position, the distance and the angle of the pupil input into the camera 108 and confirms a portion of the display 104 that the pupil is looking at. The control unit calculates coordinates of the position where the line of sight 30 stays and grasps information on the operation performed around the position.

Since the configuration and the method for grasping the position of the line of sight 30 using the camera 108 are the same as previously publicized techniques and apparent to those skilled in the art, detailed description thereof will be omitted to avoid repetition.

An embodiment of the control method of the present invention is described with reference to FIGS. 4 and 5.

First, the control unit recognizes a pupil of a user from an image photographed through the camera 108 (step S102).

If the user looks at a specific point for a predetermined time while using the user terminal 100, the control unit grasps the position of the line of sight 30 and confirms whether or not an additional input exists (step S104). After the position of the line of sight 30 is grasped by the control unit, it is preferable to maintain the coordinates of the original position of the line of sight 30 for a predetermined time although the user shifts the line of sight 30. However, the position of the line of sight 30 may be maintained for a longer time or immediately changed to a new position according to handling of the user.

As shown in FIG. 4, the user contacts with a specific handling point 40 on the touch screen display 104 using an input means 20. The input means 20 of the present invention is a means for inputting a command by contacting with the touch screen, and a generally used finger or stylus pen is a typical example.

If the input means 20 contacts with the handling point 40, the control unit calculates the coordinates of the handling point 40 (step S106). Then, as shown in FIG. 4, the control unit senses whether the user moves the handling point 40 to a point close to or far from the position of the line of sight 30 while touching the input means 20 to the display 104 (step S108).

Although the control method of the present invention can be operated by an operating system (OS) installed in the user terminal 100, it can be executed by a separate mobile application software (application).

If the handling point 40 contacting with the input means 20 moves in a direction getting close to the position of the line of sight 30, the control unit controls the screen to reduce the image expressed on the display 104 (step 5110). Contrarily, if the handling point 40 moves in a direction getting away from the position of the line of sight 30, the control unit controls the screen to enlarge the image (step S112). This method is the same as a control method used for reduction of a screen in most of touch screen smart phones currently sold in the market.

Whether the handling point 40 is getting close to or getting away from the line of sight 30 is confirmed in a method of forming an imaginary circle around the position of the line of sight 30 using the distance between the line of sight 30 and the handling point 40 as a radius and determining whether the handling point 40 moves into or out of the circumference. However, since the method of controlling the screen to enlarge or reduce an image by sensing two contacting points getting close to or getting away from each other is a general technique, another method also can be used.

If movement of the handling point 40 and control of the screen are completed, the control unit may delete information on the position of the line of sight 30 and wait for input of a new light of sight 30.

Rotation of Screen

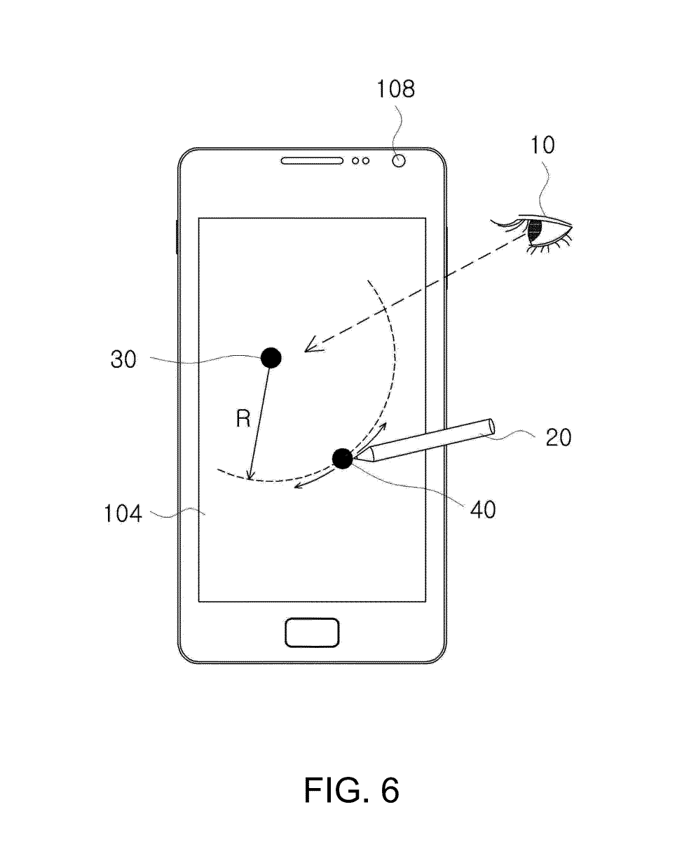

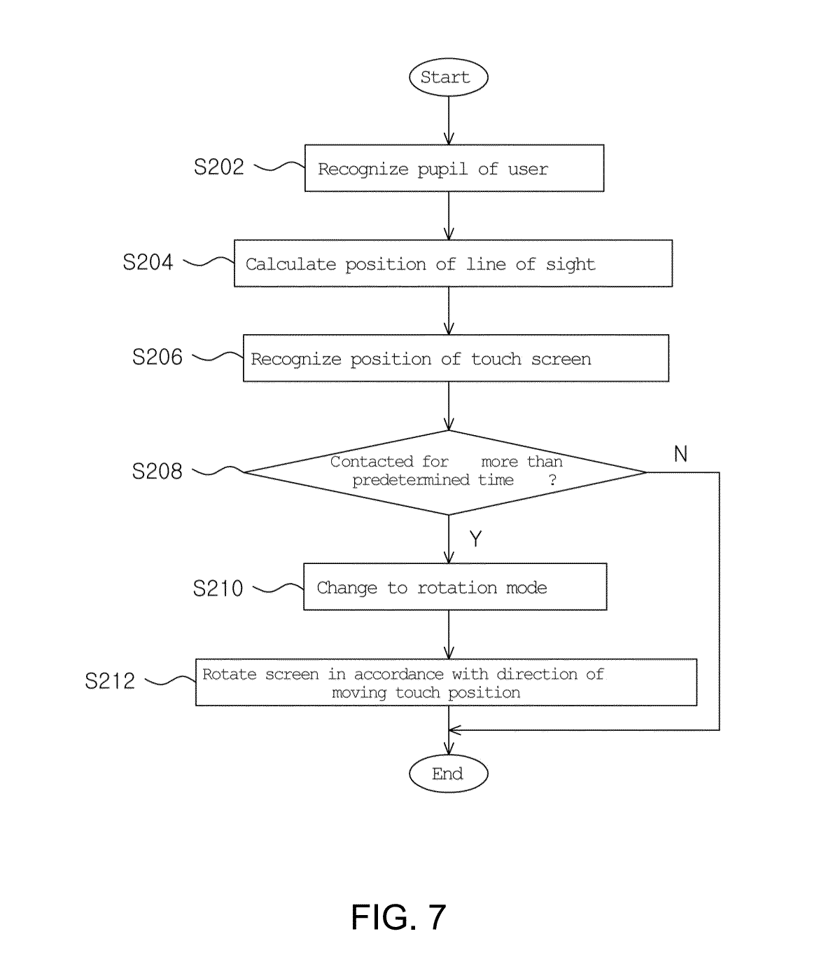

Meanwhile, FIG. 6 is a conceptual view showing a method of rotating a screen using an input means, and FIG. 7 is a flowchart illustrating a process of rotating a screen.

Another embodiment of the control method of the present invention is described with reference to FIGS. 6 and 7.

In the second embodiment, a method of rotating the screen according to the positions of the line of sight 30 and the handling point 40 is described.

In a manner the same as described above, first, the camera 108 photographs a pupil 10 of a user, and the control unit recognizes the pupil (step S202). Then, the control unit calculates the position of the line of sight 30 by calculating the position, the distance, the angle and the like of the camera 108 (step S204). Then, if a separate input means 20 contacts with the display 104, the control unit calculates the position of the handling point 40 (step S206).

This embodiment is different from the embodiment described above in that when the user uses the input means 20 to control rotation of the screen, the user should touch the input means 20 to the screen for a predetermined time or more (step S208). That is, if the position of handling point 40 is continuously maintained after the positions of the line of sight and the handling point 40 are determined, the control unit recognizes that the screen is set to a rotation mode and informs the display 104 that it is switched to a rotation mode (step S210). When the screen is set to the rotation mode, it is efficient to display a rotation direction arrow along an arc around the handling point 40 as shown in FIG. 6.

If the user moves the input means 20 along the rotation direction arrow while touching the input means 20 to the display 104, the control unit rotates the screen in a direction the same as the direction of moving the input means 20 (step S212). That is, an imaginary circle is formed around the position of the line of sight 30, and if the user moves the handling point 40 positioned on the circumference, the control unit rotates the screen clockwise or counterclockwise as much as the rotation angle of a radius connecting the line of sight 30 and the handling point 40. Such a handling can be advantageously applied when a map application or a graphic program is executed.

If movement of the input means 20 is completed, the control unit terminates the rotation mode while maintaining the rotated state of the screen as is.

Although preferred embodiments of the present invention have been described with reference to the accompanying drawings, the technical configuration of the present invention described above can be embodied in other specific forms by those skilled in the art without changing the technical spirits or essential features of the present invention. Therefore, it should be understood that the embodiments described above are illustrative and not restrictive in all aspects, and the scope of the present invention is defined by the claims described below, rather than the above detailed description, and the meaning and scope of the claims and all changes and modifications derived from equivalents thereof should be interpreted as being included in the scope of the present invention.

1. A method of controlling a touch screen by sensing a position of a line of sight, as a method of sensing a position of a line of sight 30 of a user in a touch screen type user terminal 100 attached with a camera 108 and controlling the screen to be changed in accordance with an operation of an input means 20, the method comprising:
a first step of recognizing a pupil 10 of the user from an image photographed through the camera 108, by a control unit;
a second step of grasping a position of the line of sight 30 that the pupil 10 of the user is looking at on a display 104 of the user terminal 100, by the control unit;
a third step of grasping a position of a handling point 40 contacting with the input means 20 if the user contacts with the display 104 using the input means 20;
a fourth step of sensing a change in the position of the handling point 40 by the control unit if the user moves the input means 20 while contacting with the display 104; and
a fifth step of controlling the screen to reduce an image displayed on the display 104 if the handling point 40 is getting close to the line of sight 30 and enlarge the image displayed on the display 104 if the handling point 40 is getting away from the line of sight 30, by the control unit.

2. A method of controlling a touch screen by sensing a position of a line of sight, as a method of sensing a position of a line of sight 30 of a user in a touch screen type user terminal 100 attached with a camera 108 and controlling the screen to be changed in accordance with an operation of an input means 20, the method comprising:
a first step of recognizing a pupil 10 of the user from an image photographed through the camera 108, by a control unit;
a second step of grasping a position of the line of sight 30 that the pupil 10 of the user is looking at on a display 104 of the user terminal 100, by the control unit;
a third step of grasping a position of a handling point 40 contacting with the input means 20 if the user contacts with the display 104 using the input means 20;
a fourth step of switching the user terminal 100 to a screen rotation mode by the control unit if the user touches the input means 20 to the handling point 40 for a predetermined time or more; and
a fifth step of rotating an image displayed on the display 104 in a direction the same as a direction of moving the input means 20 if the user moves the input means 20 around the line of sight 30.

3. The method according to claim 2, wherein the fifth step includes the steps of:
forming an imaginary circle around the position of the line of sight 30; and
rotating the image clockwise or counterclockwise as much as a rotation angle of a radius connecting the line of sight 30 and the handling point 40, if the user moves the handling point 40 positioned on a circumference of the imaginary circle.
